(19) United States
(12) Patent Application Publication
(10) Pub. No.: US 2024/0129105 A1
(43) Pub. Date: Apr. 18, 2024

(54) IMPROVED CONFIDENTIAL COMPUTING

(71) Applicant: VMware LLC, Palo Alto, CA (US)

(72) Inventor: Avishay Yanai, Herzliya (IL)

(21) Appl. No.: 18/047,579

(22) Filed: Oct. 18, 2022

(51) Int. Cl. H04L 9/00; H04L 9/06; H04L 9/08

(52) U.S. Cl. CPC H04L 9/008; H04L 9/0618; H04L 9/0861; H04L 2209/46

(57) ABSTRACT

An improved scheme for confidential computing that combines aspects of multi-party computation (MPC) and fully homomorphic encryption (FHE) is provided. With this improved scheme, private information regarding a confidential computation cannot leak unless the assumptions underlying both the MPC and FHE schemes are broken/compromised.

### BACKGROUND

Unless specifically indicated herein, the approaches described in this section should not be construed as prior art to the claims of the present application and are not admitted to be prior art by inclusion in this section.

Confidential computing is an umbrella term used to describe a technology that enables a party or group of parties to reliably perform computation over secret (i.e., private) data. For example, assume there is a system comprising N input parties I₁, I₂, . . . , I_{N} with private inputs x₁, x₂, . . . , x_{N} respectively. The system is tasked with computing some function ƒ over these inputs and providing the result y=ƒ (x₁, x₂, . . . , x_{N}) to an output party O. Confidential computing solves the following problem: how can the system transfer y to O, without O learning anything regarding x₁, x₂, . . . , x_{N} (except what can be inferred from y)?

Current confidential computing schemes differ based on the types of assumptions they rely on. For example, one scheme known as multi-party computation (MPC) assumes the existence of n computation parties of which at most t are corrupt (and thus at least n—t are honest). Another scheme known as fully homomorphic encryption (FHE) assumes that the mathematical parameters used in the scheme do indeed protect the private inputs.

### BRIEF DESCRIPTION OF THE DRAWINGS

FIG. 1 depicts an example confidential computing system according to certain embodiments.

FIGS. 2, 3, and 4 depict workflows for implementing techniques of the present disclosure according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to an improved scheme for confidential computing that combines aspects of MPC and FHE. With this improved scheme, output party O cannot learn anything regarding the private inputs to function ƒ unless the assumptions underlying both the MPC and FHE schemes are broken/compromised.

### 1. Example System and Solution Overview

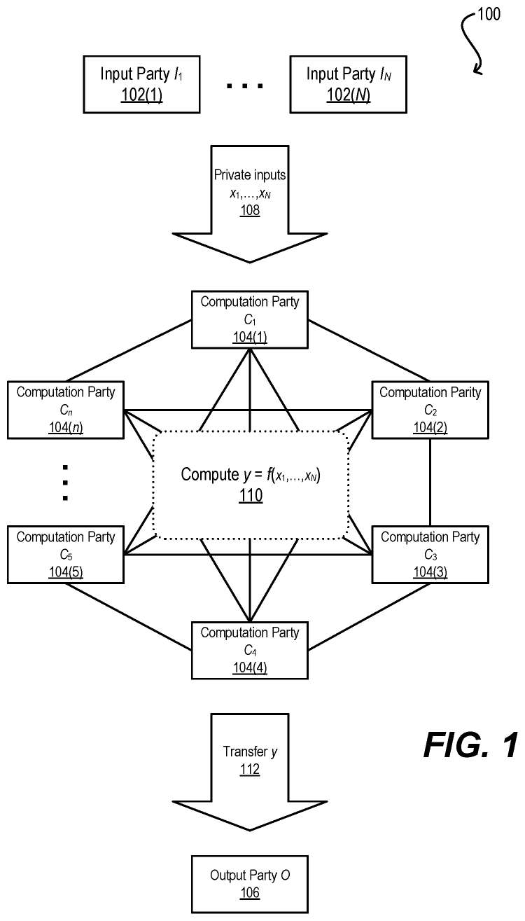

FIG. 1 depicts an example confidential computing system 100 in which the techniques of the present disclosure may be implemented. As shown, confidential computing system 100 includes N input parties I₁, I₂, . . . , I_{N} (reference numerals 102(1)-(N)), n computation parties C₁, . . . , Cₙ (reference numerals 104(1)-(n)), and an output party O (reference numeral 106). Each input party, computation party, and output party may be a physical or virtual computer system/device. Although input parties I₁, . . . , I_{N} are shown as being distinct from computation parties C₁, . . . , Cₙ, in some embodiments one or more input parties may also act as a computation party (and vice versa). For instance, in a particular embodiment, N may equal n and each input party Iᵢ may be the same as computation party Cᵢ. Further, although output party O is shown as a singular entity that is distinct from computation parties C₁, . . . , Cₙ, in some embodiments output party O may be a computation party or a group of computation parties.

Generally speaking, the goal of confidential computing system 100 is for computation parties C₁, . . . , Cₙ to compute an N-ary function ƒ over a set of private inputs x₁, . . . , x_{N} held by input parties I₁, . . . , I_{N} respectively and transfer the result y=ƒ(x₁, . . . , x_{N}) to output party O in a manner that ensures O does not learn anything regarding x₁, . . . , x_{N}, except whatever can be inferred from y (shown via reference numerals 108-112). Each input xᵢ is private in the sense that it is known only by its corresponding input party Iᵢ and should be kept secret from everyone else (including the computation parties, assuming they are different from the input parties). Two existing schemes for achieving this goal are multi-party computation (MPC) and fully homomorphic encryption (FHE). Each of these schemes is described in turn below.

### 1.1 Multi-Party Computation

MPC assumes that at most t of the n computation parties C₁, . . . , Cₙ are corrupt and may collude (and thus at least n-t computation parties are honest). As long as this assumption holds, MPC guarantees that any subset of t computation parties cannot learn anything regarding private inputs x₁, . . . , x_{N}, while output party learns only y=ƒ(x₁, . . . , x_{N}).

In various embodiments, MPC employs a computation compilation algorithm (Π, Input, Output)←Compile (1^{κ}, ƒ, n) where:
κ is a security parameter;
n is the number of computation parties;
ƒ is the function to be computed by the computation parties;
Π is a vector of “next-message” functions Π=(Π₁, . . . , Πₙ) with Πᵢ being the next-message function for computation party Cᵢ;
Input is an algorithm takes an input a value x and outputs n messages intended to be sent to computation parties C₁, . . . , Cₙ respectively; and
Output is an algorithm that takes as input n messages received from computation parties C₁, . . . , Cₙ respectively and outputs the result of function ƒ on the original private inputs (if feasible).

With this Compile algorithm in mind, MPC typically proceeds as follows:
1. Each input party Iᵢ computes (msg_{i,1}, . . . , msg_{i,n})←Input(xᵢ) and sends msg_{i,j} to computation party Cⱼ, whose state stⱼ is initialized to null or ⊥ (i.e., the truth value “false”).
2. Upon receiving a given message msgᵢₙ, each computation party Cⱼ computes (msg, stⱼ′)←Πᵢ(stⱼ, msgᵢₙ) and determines whether state stⱼ′ indicates that it should halt. If so, Cⱼ terminates its processing; otherwise, Cⱼ updates its state stⱼ with stⱼ′, interprets msg as a vector of output messages (msg_{out,1}, . . . , msg_{out,n}, msg_{out,O}), sends msg_{out,k} to Cₖ, and sends msg_{out,O} to output party O. Each computation party will continue processing incoming messages in this manner until the state generated by its next-message function indicates that it should halt.

3. Concurrently with (1) and (2), output party O initializes a vector of output values (out₁, . . . , outₙ) to (⊥, . . . , ⊥) and, upon receiving an output message msgⱼ from a computation party Cⱼ, changes outⱼ to msgⱼ and runs output=Output(out₁, . . . , outₙ). For each execution of the Output algorithm, O may decide to halt depending on the value of output. If O decides to halt, O uses output as the output of function ƒ (i.e., y) and the MPC process ends.

### 1.2 Fully Homomorphic Encryption

FHE assumes the existence of a secure homomorphic encryption scheme that consists of the following algorithms:
(pk, sk, ek)←Gen(1^{κ})—Gen receives as input the security parameter κ and outputs three keys: a public encryption key pk, a secret decryption key sk, and a public evaluation key ek.
ct←Enc(pk, pt)—Enc receives as input a public encryption key pk and a plaintext pt and outputs the ciphertext ct.
pt←Dec(sk, ct)—Dec receives as input a secret decryption key sk and a ciphertext ct and outputs a plaintext pt.
ct′←Eval(ek, ƒ, ct₁, . . . , ctₘ) —Eval receives as input a public evaluation key ek, a description of anm-ary function ƒ(x₁, . . . , xₘ), and m ciphertexts, and outputs a ciphertext ct′.

If it is configured correctly (i.e., employs correct/appropriate mathematical parameters), a secure homomorphic encryption scheme exhibits the following properties:
Correctness—It holds that D ec (sk, Enc(pk, pt))=pt where (pk, sk, ek)←Gen(1^{κ}).
Security—This follows the usual chosen-plaintext-attack (CPA) security definition of an encryption scheme.
Utility—For every (pk, sk, ek)←Gen(1^{κ}) and every m-ary function ƒ(x₁, . . . , xₘ), let ct₁, . . . , ctₘ be the m ciphertexts and pt₁, . . . , ptₘ be their corresponding plaintexts; it holds that ƒ(pt₁, . . . , ptₘ)=Dec(sk, Eval(ek, ƒ, ct₁, . . . , ctₘ)). In other words, the ciphertext ct′ generated by the Eval algorithm on ek, ƒ, and ct₁, . . . , ctₘ can be decrypted to obtain ƒ(pt₁, . . . , ptₘ).

With the foregoing algorithms in mind, FHE typically proceeds as follows:
1. Output party O runs (pk, sk, ek)←Gen(1^{κ}), provides pk to everyone, and provides ek to a computation party C.
2. Each input party Iᵢ computes ctᵢ←Enc(pk, xᵢ) to C.
3. Computation party C computes ct←Eval(ek, ƒ, ct₁, . . . , ctₘ) and sends ct to output party O.
4. Output party O computes pt←Dec(sk, ct) and uses pt as the output of function ƒ on the original private inputs x₁, . . . , x_{N} (i.e., y).

### 1.3 Combining MPC and FHE

One issue with using either MPC or FHE in isolation to implement confidential computing is that the assumption(s) underlying the chosen scheme may be broken. For example, with respect to MPC, the assumption is that at most t computation parties are corrupt. However, an adversary that has knowledge of this may work hard to corrupt t+1 computation parties. If the adversary is successful in this endeavor, security is no longer guaranteed and the adversary may be able to learn the private inputs.

With respect to FHE, the assumption is that the mathematical parameters used by the FHE scheme ensure security and thus protect the private inputs. However, it is possible for one or more of these parameters to be configured incorrectly, thereby leading to leakage of the private inputs.

To address the foregoing, embodiments of the present disclosure provide an improved confidential computing scheme (referred to herein as “hybrid MPC/FHE”) that combines MPC and FHE in a novel way. As elaborated upon in section (2) below, hybrid MPC/FHE leverages the MPC framework but incorporates the following high-level changes:
Function ƒ that is provided as input to the MPC Compile algorithm is replaced with the Eval algorithm from FHE.
Each input party Iᵢ encrypts its private input xᵢ using the Enc algorithm from FHE to generate a ciphertext ctᵢ and runs the Input algorithm on ctᵢ, rather than on xᵢ.
At the end of the process, output party O obtains ct←Eval(ek, ƒ, ct₁, . . . , ctₘ) and computes output=Dec(sk, ct).

With this improved scheme, the assumptions underlying both MPC and FHE (i.e., at most t corrupt computation parties and correct configuration of the FHE scheme) must be broken in order for private information to leak. If at least one of these two assumptions holds, hybrid MPC/FHE remains secure, which is a significantly stronger security guarantee than what is provided by MPC and FHE alone.

It should be appreciated that FIG. 1 and the foregoing high-level description of hybrid MPC/FHE are illustrative and not intended to limit embodiments of the present disclosure. For example, as indicated previously, although FIG. 1 depicts a particular arrangement of input parties, computation parties, and output parties, other arrangements are possible (e.g., one or more input parties may overlap with one or more computation parties, the output party may overlap with one or more computation parties, etc.). One of ordinary skill in the art will recognize other variations, modifications, and alternatives.

### 2. Hybrid MPC/FHE Workflows

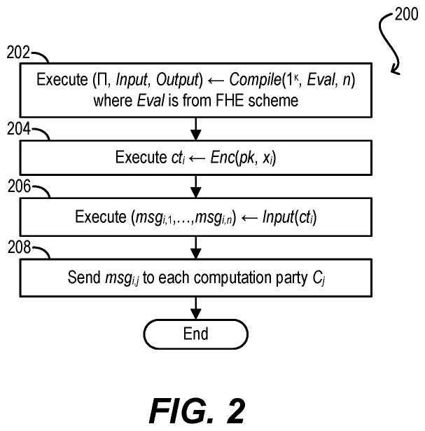

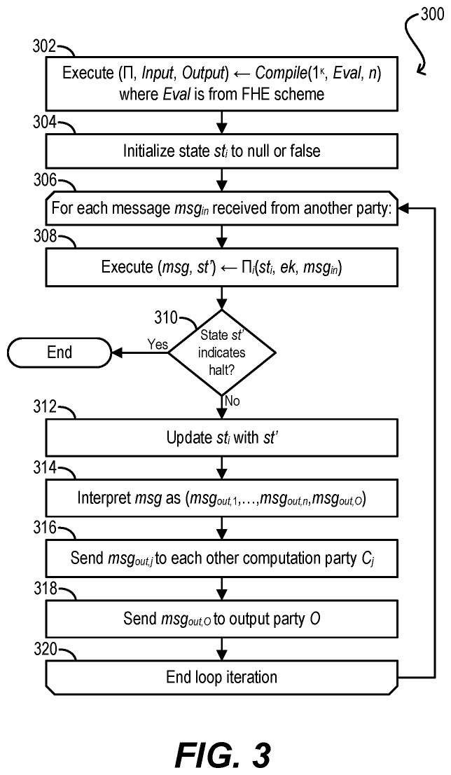

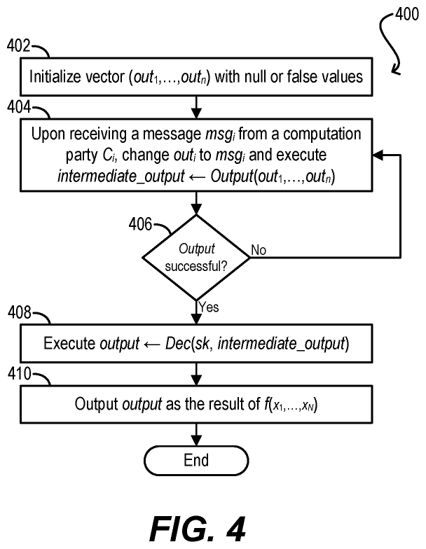

FIGS. 2, 3, and 4 depict workflows 200, 300, and 400 respectively for implementing hybrid MPC/FHE in the context of confidential computing system 100 of FIG. 1 according to certain embodiments. In particular, workflow 200 of FIG. 2 comprises steps that may be performed by each input party Iᵢ for i=1, . . . , N, workflow 300 of FIG. 3 comprises steps that may be performed by each computation party Cᵢ for i=1, . . . , n, and workflow 400 of FIG. 4 comprises steps that may be performed by output party O.

In various embodiments, these workflows assume that output party O has executed the FHE algorithm (pk, sk, ek)←Gen(1^{κ}) and has published pk to the input parties and ek to the computation parties. These workflows also assume that each party is associated with a message ingress queue so that the messages sent to it are saved until their turn to be processed.

Starting with workflow 200, at step 202 input party Iᵢ can execute (Π, Input, Output)←Compile (1^{κ}, Eval, n) where Eval is the Eval algorithm from the FHE scheme. Note that this is different from the standard MPC process in which Compile is provided function ƒ as one of the inputs. The outputs of this execution are the vector of next-message functions Π=(Π₁, . . . , Πₙ), the Input algorithm, and the Output algorithm.

At step 204 input party Iᵢ can execute ctᵢ←Enc(pk, xᵢ), which takes as input the public key pk received from output party O and the input party's private input xᵢ and outputs ciphertext ctᵢ.

At step 206 input party Iᵢ can execute (msg_{i,1}, . . . , msg_{i,n}) Input(ctᵢ), which takes as input ciphertext ctᵢ and outputs a vector of messages (msg_{i,1}, . . . , msg_{i,n}) (step 206).

Finally, at step 208 input party Iᵢ can send msg_{i,j} to each computation party Cⱼ.

Turning now to workflow 300, at step 302 computation party Cᵢ can execute (Π, Input, Output)←Compile(1^{κ}, Eval, n) where Eval is the Eval algorithm from the FHE scheme. This step is identical to step 202 of workflow 200.

At step 304 computation party Cᵢ can initialize its state stᵢ to null or ⊥.

At step 306 computation party Cᵢ can enter a loop for each message msgᵢₙ received from an input party or another computation party. Within this loop computation party Cᵢ can execute its next-message function (msg, st′)←Πᵢ(st, ek, msgᵢₙ), which takes as input state stᵢ, the evaluation key ek received from output party O, and msgᵢₙ and outputs an output message msg and an output state st′ (step 308). In some embodiments Cᵢ may incorporate ek into its initial state st, in which case ek does not need be provided as a separate input into its next-message function.

Upon executing the next-message function, computation party Cᵢ can check whether output state st′ indicates halt (i.e., corresponds to a halt signal) (step 310). If the answer is yes, Cᵢ can terminate its processing and workflow 300 can end.

However, if the answer at decision step 310 is no, computation party Cᵢ can update its state stᵢ with st′ (step 312) and interpret output message msg as a vector of output messages (msg_{out,1}, . . . , msg_{out,n}, msg_{out,O}) (step 314). Cᵢ can then send msg_{out,j} to each other computation party Cⱼ (step 316) and send msg_{out,O} to output party O (step 318).

Finally, at step 320 computation party Cᵢ can reach the end of the current loop iteration and return to the top of the loop to process the next incoming message.

Turning now to workflow 400, at step 402 output party O can initialize its vector of output values (out₁, . . . , outₙ) to all null or ⊥ values. Then, upon receiving a message msgᵢ from a computation party Cᵢ, O change outᵢ to msgᵢ and execute intermediate_output←Output(out₁, . . . , outₙ) (step 404).

If the execution of the Output algorithm is successful (or in other words, if the resulting intermediate_output is a valid value) (step 406), output party O can execute output=(Dec(sk, intermediate_output)), which takes as input the secret key sk and intermediate_output and generates a final output output (step 408). O can then output output as the result of function ƒ on the original private inputs x₁, . . . , x_{N} (step 410) and workflow 400 can end.

However, if the answer at decision step 406 is no, output party O can return to step 404 to process the next incoming message.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
executing, by a computer system acting as an input party in a set of N input parties, a computation compilation algorithm of a multi-party computation (MPC) scheme, wherein the computation compilation algorithm takes as input a security parameter, an evaluation algorithm of a fully homomorphic encryption (FHE) scheme, and a value n corresponding to a set of n computation parties configured to confidentially compute a function ƒ over N private inputs held by the set of N input parties, and wherein the computation compilation algorithm outputs a next-message function, an input algorithm, and an output algorithm;
executing, by the computer system, an encryption algorithm of the FHE scheme on a private input of the input party using a public encryption key, the executing of the encryption algorithm resulting in a ciphertext;
executing, by the computer system, the input algorithm on the ciphertext, the executing of the input algorithm resulting in a vector of n messages; and
transmitting, by the computer system, each message in the vector of n messages to a computation party in the set of n computation parties.

2. The method of claim 1 wherein the computation party initializes a state to null or false, and wherein upon receiving the message, the computation party:
executes the next-message function on the message and a public evaluation key, the executing of the next-message function resulting in a new message and a new state; and
determines whether the new state indicates that the computation party should halt its processing.

3. The method of claim 2 wherein, upon determining that the new state does not indicate that the computation party should halt its processing, the computation party further:
updates the state with the new state;
interprets the new message as a vector of n+1 output messages corresponding to the set of n computation parties and an output party; and
transmits each output message in the vector of n+1 output messages to a corresponding computation party or output party.

4. The method of claim 3 wherein the output party initializes a vector of output values with null or false values, and wherein upon receiving the output message, the output party:
replaces an output value in the vector of output values with the output message; and
attempts to execute the output algorithm on the vector of output values.

5. The method of claim 4 wherein upon successfully executing the output algorithm, the output party:
executes a decryption algorithm of the FHE scheme on an intermediate output generated by the output algorithm using a secret decryption key, the executing of the decryption algorithm resulting in a final output value; and
outputs the final output value as an output of computing the function ƒ over the N private inputs.

6. The method of claim 5 wherein the public evaluation key, the public encryption key, and the secret decryption key are generated via a key generation algorithm of the FHE scheme.

7. The method of claim 6 wherein the key generation algorithm is executed by the output party, wherein the output party publishes the public encryption key to the set of N input parties, and wherein the output party publishes the public evaluation key to the set of n computation parties.

8. A non-transitory computer readable storage medium having stored thereon program code executable by a computer system acting as input party in a set of N input parties, the program code embodying a method comprising:
executing a computation compilation algorithm of a multi-party computation (MPC) scheme, wherein the computation compilation algorithm takes as input a security parameter, an evaluation algorithm of a fully homomorphic encryption (FHE) scheme, and a value n corresponding to a set of n computation parties configured to confidentially compute a function ƒ over N private inputs held by the set of N input parties, and wherein the computation compilation algorithm outputs a next-message function, an input algorithm, and an output algorithm;
executing an encryption algorithm of the FHE scheme on a private input of the input party using a public encryption key, the executing of the encryption algorithm resulting in a ciphertext;
executing the input algorithm on the ciphertext, the executing of the input algorithm resulting in a vector of n messages; and
transmitting each message in the vector of n messages to a computation party in the set of n computation parties.

9. The non-transitory computer readable storage medium of claim 8 wherein the computation party initializes a state to null or false, and wherein upon receiving the message, the computation party:
executes the next-message function on the message and a public evaluation key, the executing of the next-message function resulting in a new message and a new state; and
determines whether the new state indicates that the computation party should halt its processing.

10. The non-transitory computer readable storage medium of claim 9 wherein, upon determining that the new state does not indicate that the computation party should halt its processing, the computation party further:
updates the state with the new state;
interprets the new message as a vector of n+1 output messages corresponding to the set of n computation parties and an output party; and
transmits each output message in the vector of n+1 output messages to a corresponding computation party or output party.

11. The non-transitory computer readable storage medium of claim 10 wherein the output party initializes a vector of output values with null or false values, and wherein upon receiving the output message, the output party:
replaces an output value in the vector of output values with the output message; and
attempts to execute the output algorithm on the vector of output values.

12. The non-transitory computer readable storage medium of claim 11 wherein upon successfully executing the output algorithm, the output party:
executes a decryption algorithm of the FHE scheme on an intermediate output generated by the output algorithm using a secret decryption key, the executing of the decryption algorithm resulting in a final output value; and
outputs the final output value as an output of computing the function ƒ over the N private inputs.

13. The non-transitory computer readable storage medium of claim 12 wherein the public evaluation key, the public encryption key, and the secret decryption key are generated via a key generation algorithm of the FHE scheme.

14. The non-transitory computer readable storage medium of claim 13 wherein the key generation algorithm is executed by the output party, wherein the output party publishes the public encryption key to the set of N input parties, and wherein the output party publishes the public evaluation key to the set of n computation parties.

15. A computer system acting as input party in a set of N input parties, the computer system comprising:
a processor; and
a non-transitory computer readable medium having stored thereon program code that, when executed, causes the processor to:
execute a computation compilation algorithm of a multi-party computation (MPC) scheme, wherein the computation compilation algorithm takes as input a security parameter, an evaluation algorithm of a fully homomorphic encryption (FHE) scheme, and a value n corresponding to a set of n computation parties configured to confidentially compute a function ƒ over N private inputs held by the set of N input parties, and wherein the computation compilation algorithm outputs a next-message function, an input algorithm, and an output algorithm;
execute an encryption algorithm of the FHE scheme on a private input of the input party suing a public encryption key, the executing of the encryption algorithm resulting in a ciphertext;
execute the input algorithm on the ciphertext, the executing of the input algorithm resulting in a vector of n messages; and
transmit each message in the vector of n messages to a computation party in the set of n computation parties.

16. The computer system of claim 15 wherein the computation party initializes a state to null or false, and wherein upon receiving the message, the computation party:
executes the next-message function on the message and a public evaluation key, the executing of the next-message function resulting in a new message and a new state; and
determines whether the new state indicates that the computation party should halt its processing.

17. The computer system of claim 16 wherein, upon determining that the new state does not indicate that the computation party should halt its processing, the computation party further:
updates the state with the new state;
interprets the new message as a vector of n+1 output messages corresponding to the set of n computation parties and an output party; and
transmits each output message in the vector of n+1 output messages to a corresponding computation party or output party.

18. The computer system of claim 17 wherein the output party initializes a vector of output values with null or false values, and wherein upon receiving the output message, the output party:
replaces an output value in the vector of output values with the output message; and
attempts to execute the output algorithm on the vector of output values.

19. The computer system of claim 18 wherein upon successfully executing the output algorithm, the output party:
executes a decryption algorithm of the FHE scheme on an intermediate output generated by the output algorithm using a secret decryption key, the executing of the decryption algorithm resulting in a final output value; and
outputs the final output value as an output of computing the function ƒ over the N private inputs.

20. The computer system of claim 19 wherein the public evaluation key, the public encryption key, and the secret decryption key are generated via a key generation algorithm of the FHE scheme.

21. The computer system of claim 20 wherein the key generation algorithm is executed by the output party, wherein the output party publishes the public encryption key to the set of N input parties, and wherein the output party publishes the public evaluation key to the set of n computation parties.
